(19) United States
(12) Patent Application Publication
(10) Pub. No.: US 2010/0077442 A1
(43) Pub. Date: Mar. 25, 2010

(54) COMMUNICATION CONTROL DEVICE AND COMMUNICATION CONTROL METHOD IN AUDIO VISUAL DEVICE SYSTEM, AND TELEVISION RECEIVER

(75) Inventor: Kazumi Suga, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/565,649

(22) Filed: Sep. 23, 2009

(30) Foreign Application Priority Data
Sep. 25, 2008 (JP) 2008-246545

(51) Int. Cl. H04N 7/16

(52) U.S. Cl. 725/149

(57) ABSTRACT

When disconnection of an audio visual device from an audio visual device system is detected, a control unit in a communication control device performs control for causing an audio visual device that has not acquired a logical address corresponding to a device type thereof among a plurality of audio visual devices connected to a repeater device to acquire a logical address corresponding to the device type.

### BACKGROUND OF THE INVENTION

1. Field of the Invention

The present invention relates to a communication control device and a communication control method in an audio visual device system, and a television receiver.

2. Description of the Related Art

In HDMI (High-Definition Multimedia Interface), since it is possible to recognize devices connected to each other, the devices can be controlled and caused to cooperate with each other in addition to that video and audio signals can be transferred through a cable. Data transmission/reception and communication (refer to “High-Definition Multimedia Interface Specification Version 1.3a”) of a system in which a television receiver (TV receiver) is connected to recording devices such as a hard disc recorder through HDMI will be explained using a block diagram of FIG. 12 and a timing chart of FIG. 13.

First, a procedure for recording devices 902 and 903 to acquire physical addresses will be explained. When the recording devices 902 and 903 set 5V PWR (+5V power supply) lines to high, the TV receiver 901 sets an HPD (Hot-Plug Detect) line to high. It is found that the recording devices 902 and 903 can perform a DDC (Display Data Channel) communication by these operations. Thereafter, the recording device 902 or 903 acquires a physical address from an EDID-ROM (Extended Display Information Data Read Only Memory) (not shown) of the TV receiver 901 by a DDC communication. DDC is a standard determined by VESA (Video Electronics Standards Association) to transmit display-related information stored in the EDID-ROM to a display data transmission side by communication. Here, the physical address of the TV receiver 901 is fixed to 0.0.0.0. The physical addresses of the recording devices 902 and 903 are prescribed in the EDID-ROMs connected to respective HDMI ports of the TV receiver 901 and are set to, for example, 1.0.0.0 and 2.0.0.0.

Subsequently, when the TV receiver 901 switches the recording device 902, the recording device 902 communicates with an HDCP-ROM (High-bandwidth Digital Content Protection ROM) of the TV receiver 901 by the DDC communication. With this operation, an authentication process as to copyright protection is performed, and a cipher key is shared. Thereafter, the recording device 902 can actually transmit image data and audio data to the TV receiver 901.

Next, a method of acquiring a logical address will be explained. Logical addresses which can be acquired are previously determined for each of device types (refer to FIG. 11). For example, the logical address of a recording device is set to any of “1”, “2”, and “9”. Accordingly, the number of logical addresses of each device type has an upper limit allocated thereto. The recording device 902 transmits, by broadcast, a Polling message to a logical address (for example, “1”) the acquisition of which is desired by the recording device 902. When no response to the message returns from any device (when a message returns in the state of ACK bit=1), it can be found that the logical address is available, and the recording device 902 acquires the logical address. When a response returns (when a message of ACK bit=0 returns), on the other hand, the logical address is already acquired by another device. In this case, a logical address is acquired by repeating a similar process for other logical addresses (for example, “2” and “9”) (refer to, for example, Japanese Patent Laid-Open No. 2007-202115 and “High-Definition Multimedia Interface Specification Version 1.3a”). FIG. 13 shows timings at which the processes described above are performed. In FIG. 13, the horizontal axis shows time, and processes on the vertical axis are time-sequentially performed from left to right.

In an HDMI system, furthermore, a repeater device (such as an AV (audio visual) amplifier) having a plurality of HDMI input terminals may be used. In HDMI-CEC (High-Definition Multimedia Interface Consumer Electronics Control), all devices are connected via a bus. Thus, even in a case where a repeater device is connected to a TV receiver, the TV receiver can control a device connected to the repeater device according to the CEC standard. With the use of such a repeater device, therefore, for example, even a TV receiver having a single HDMI terminal can control a plurality of recording devices according to the CEC standard.

An audio visual device system will now be considered in which an output terminal of a repeater device such as an AV amplifier is connected to an input terminal of a television receiver and in which output terminals of a plurality of recording devices are connected to input terminals of the repeater device. When three recording devices have already been connected to the input terminals of the repeater device, no more logical addresses are available for recording devices even if another, or the fourth recording device is connected to the repeater device. Thus, no logical address can be acquired for the fourth recording. Therefore, the fourth recording device cannot be subjected to CEC control.

Further, since a logical address is acquired at the time when a device is connected, even if a logical address is made available after any of the three recording devices is disconnected, the fourth recording device cannot acquire the logical address.

Further, in a case where a recording device is connected to a television receiver through a repeater device, that is, in a case where a recording device is not directly connected to a television receiver, it is not easy for the television receiver to detect the connection/disconnection of the recording device.

These problems are not unique to a recording device but occur in other types of audio visual devices (such as a receiving device, a playback device, and an acoustic device). Although explanation is made here as to an HDMI system as an example, these problems are applied not only to the HDMI system but also to general audio visual systems in which an upper limit is set on the number of logical addresses to be allocated according to a device type.

### SUMMARY OF THE INVENTION

The present invention provides a television receiver in an audio visual device system in which an upper limit is set on the number of logical addresses for a device type and in which a repeater device is connected between the television receiver and a plurality of audio visual devices, wherein an audio visual device connected to an input terminal of the repeater device, which has failed to acquire a logical address corresponding to a device type, can acquire a logical address when the logical address is made available.

A first aspect of the present invention relates to a communication control device in an audio visual device system, the audio visual device system being arranged such that a repeater device is connected to an input terminal of the communication control device and a plurality of audio visual devices are connected to a plurality of input terminals of the repeater device, each of the connected audio visual devices being allocated a logical address corresponding to a device type thereof, an upper limit being set on the number of allocatable logical addresses for each device type so that when a number of audio visual devices that exceed the upper limit are connected, an excessive audio visual device is not allocated a logical address corresponding to a device type thereof. The communication control device includes a device detection unit configured to detect an audio visual device which has not acquired a logical address corresponding to a device type of the audio visual device among the plurality of audio visual devices connected to the repeater device; a disconnection detection unit configured to detect disconnection of an audio visual device from the audio visual device system; and a control unit configured to perform control for causing the audio visual device detected by the device detection unit to acquire a logical address corresponding to the device type when the disconnection detection unit detects disconnection of an audio visual device.

A second aspect of the present invention relates to a television receiver including a tuner unit configured to receive a television broadcast signal, a display unit configured to display the received television broadcast signal, and the communication control device described above.

Further, a third aspect of the present invention relates to a communication control method in an audio visual device system, the audio visual device system being arranged such that a repeater device is connected to an input terminal of the communication control device and a plurality of audio visual devices are connected to a plurality of input terminals of the repeater device, each of the connected audio visual devices being allocated a logical address corresponding to a device type thereof, an upper limit being set on the number of allocatable logical addresses for each device type so that when a number of audio visual devices that exceed the upper limit are connected, an excessive audio visual device is not allocated a logical address corresponding to a device type thereof. The communication control method includes a device detection step of detecting an audio visual device which has not acquired a logical address corresponding to a device type of the audio visual device among the plurality of audio visual devices connected to the repeater device; a disconnection detection step of detecting disconnection of an audio visual device from the audio visual device system; and a control step of performing control for causing the audio visual device detected in the device detection step to acquire a logical address corresponding to the device type when disconnection of an audio visual device is detected in the disconnection detection step.

Further features of the present invention will become apparent from the following description of exemplary embodiments with reference to the attached drawings.

### BRIEF DESCRIPTION OF THE DRAWINGS

FIG. 1 is a block diagram explaining an overall configuration according to an embodiment of the present invention.

FIG. 2 is a diagram explaining a connecting portion between a television receiver and peripheral devices in the embodiment of the present invention.

FIG. 3 is a block diagram explaining a communication control unit according to a first embodiment.

FIG. 4A is a diagram showing a basic structure of the header/data block of a CEC message.

FIG. 4B is a diagram showing a detailed structure of the header block of the CEC message.

FIG. 5 is a diagram explaining a device management table for managing a logical address, a physical address, and a device type of a device connected to each HDMI terminal.

FIG. 6 is a flowchart showing a logical address reacquisition controlling process performed by the communication control unit according to the first embodiment.

FIG. 7 is a flowchart showing a logical address reacquisition controlling process performed by a communication control unit according to a second embodiment.

FIG. 8 is a block diagram explaining the communication control unit according to the second embodiment.

FIG. 9 is a flowchart showing a logical address reacquisition controlling process performed by a communication control unit according to a third embodiment.

FIG. 10 is a block diagram explaining the communication control unit according to the third embodiment.

FIG. 11 is a diagram showing logical addresses specified according to device types in the HDMI standard.

FIG. 12 is a block diagram explaining a conventional technology concerning communication in a system in which devices are connected according to the HDMI standard.

FIG. 13 is a timing chart explaining a conventional technology concerning communication in a system in which devices are connected according to the HDMI standard.

### DESCRIPTION OF THE EMBODIMENTS

### First Embodiment

A first embodiment of the present invention will now be explained referring to the drawings.

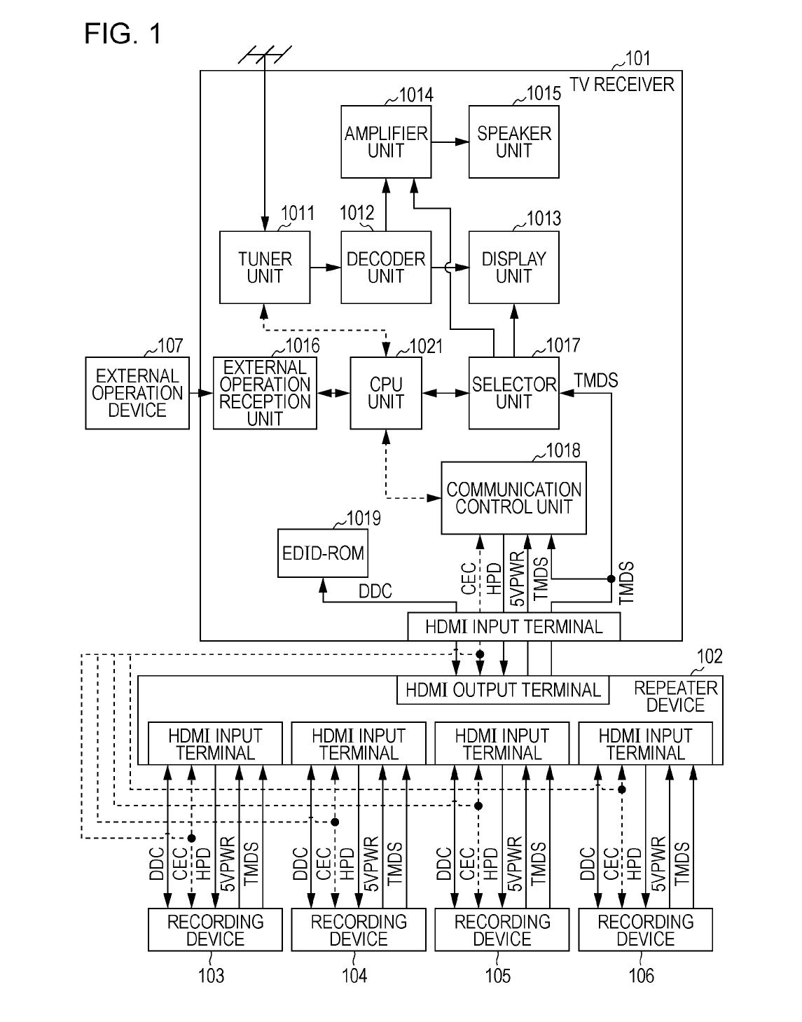

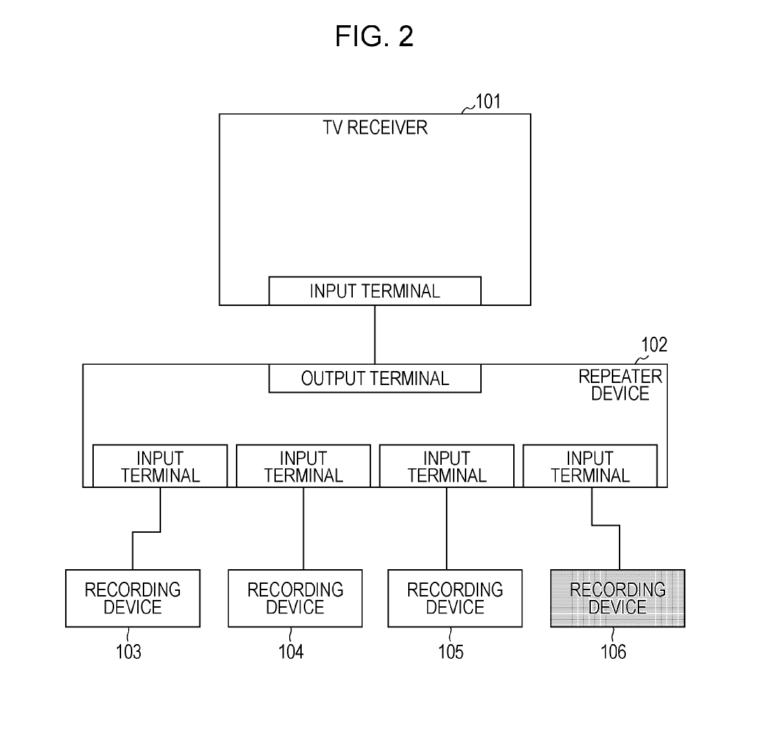

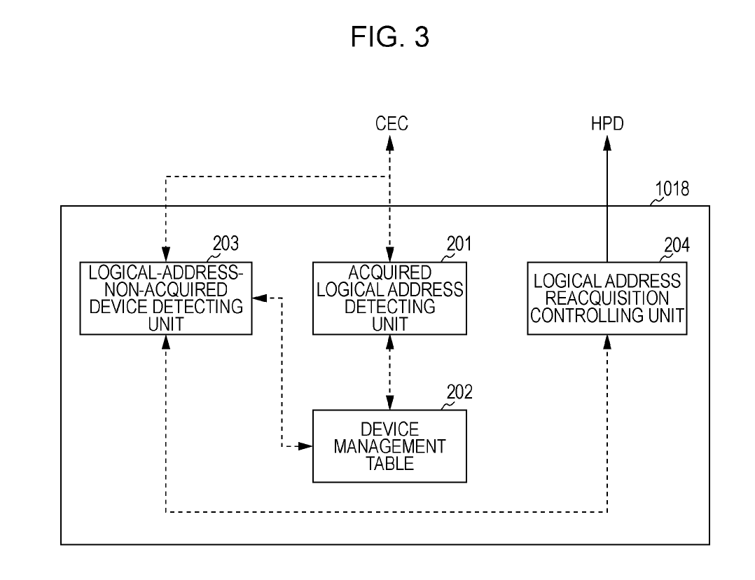

An audio visual (AV) device system according to the first embodiment is a system compatible with the HDMI standard. FIGS. 1 and 2 show the configuration of the audio visual device system. In the audio visual device system according to the present embodiment, generally, a repeater device 102 having four input terminals is connected to a television receiver 101. More specifically, as shown in FIG. 1, the audio visual device system includes the television receiver 101, the repeater device 102, recording devices 103 to 106, and an external operation device 107. The television receiver 101 includes a tuner unit 1011, a decoder unit 1012, a display unit 1013, an amplifier unit 1014, a speaker unit 1015, an external operation reception unit 1016, a selector unit 1017, a communication control unit 1018, and an EDID-ROM 1019. Further, as shown in FIG. 3, the communication control unit 1018 according to the embodiment includes an acquired-logical-address detecting unit 201, a device management table 202, a logical-address-non-acquired device detecting unit 203, and a logical address reacquisition controlling unit 204.

### Gist of First Embodiment

In the first embodiment, a process for detecting a device that has failed to acquire a logical address because a number of devices exceeding an upper limit number of logical addresses have been connected, and causing the device to acquire a logical address when it is made available is performed using only a standard message compliant with the HDMI-CEC standard.

Specifically, the detection of the failure to acquire a logical address of the recording device 106 can be performed by confirming on a CEC line that three logical addresses of recording devices have already been acquired and that the recording device 106 has failed to acquire a logical address.

Further, the detection that a logical address of a recording device has been made available can be performed by regularly sending a Ping message to the three logical addresses of recording devices and checking response bits.

Furthermore, the power of the repeater device 102 is turned off and is then turned on by using the television receiver 101, thereby allowing the recording device 106 to reacquire a logical address.

The term “standard message” refers to a standard message described in the “High-Definition Multimedia Interface Specification Version 1.3a”, except for a message determined by a vendor.

A device other than a recording device, such as a playback device, may also be connected to an input terminal of the repeater device 102. However, in the present embodiment, the connection of the fourth recording device 106 that is outside the upper limit number (three) of logical addresses of recording devices will be described.

The elements shown in a block diagram of FIG. 1 will be explained in detail.

### (Tuner Unit)

A television broadcast signal received by an antenna is input to the tuner unit 1011. The tuner unit 1011 acquires the information (frequency, TS_ID) of a channel to be received from a CPU (central processing unit) unit 1021 and outputs a desired TS (transport stream) after switching the frequency. The TS data is subjected to a descramble process by the MULTI2 cipher system (ARIB STD-B25, the Third Chapter), and is then demultiplexed to a PES (Packetized Elementary Streams) packet and section data. The PES packet includes an audio stream, a video stream, and the like of MPEG-2. Further, the section data includes PSI (Program Specific Information) for transmitting program information, Carrousel data for broadcasting data, and the like. The video stream data and the audio stream data are output to the decoder unit 1012, and the PSI section is stored in the CPU unit 1021 after SI (Service Information) necessary to acquire information as to the program is acquired.

### (Decoder Unit, Display Unit, Amplifier Unit, Speaker Unit, Selector Unit)

The video stream data is subjected to a video decode process described in the Sixth Chapter of ARIB STD-B21, “6.1 Video Decoding Process and Output” by the decoder unit 1012 and is output to and displayed on the display unit 1013. The audio stream data is subjected to an audio decode process described in the Sixth Chapter of ARIB STD-B21, “6.2 Audio Decoding Process and Output” and is output from the speaker unit 1015 through the amplifier unit 1014.

Further, the video data and the audio data played back by the recording devices 103 to 106 are switched by the selector unit 1017 and are output to the display unit 1013 and the amplifier unit 1014. The switching control of the selector unit 1017 is performed by the CPU unit 1021.

### (External Operation Device, External Operation Reception Unit)

A user performs an operation such as recording by using the external operation device 107 such as a remote controller, and the external operation reception unit 1016 receives a signal. The received signal is detected by the CPU unit 1021.

The CPU unit 1021 controls the communication control unit 1018 based on the received signal indicative of the user operation to create a CEC message such as a power supply control message or a recording message, and transmits the CEC message to the recording devices 103 to 106.

On the contrary, CEC messages transmitted from the recording devices 103 to 106 are received by the communication control unit 1018 and are transmitted to the CPU unit 1021 for analysis.

### (Communication Control Unit, EDID-ROM)

The communication control unit 1018 returns a response in response to a physical address acquisition request (for setting a 5V PWR line from low to high) from the repeater device 102 (when the acquisition is permitted, an HPD line is set from low to high, otherwise it remains low). When the acquisition is permitted, the repeater device 102 performs a DDC communication with the EDID-ROM 1019 and acquires a physical address. A physical address is allocated to each of the HDMI terminals and is stored in the EDID-ROM 1019. The EDID-ROM 1019 may be provided in each HDMI terminal. Alternatively, if possible, a single EDID-ROM may be switched so that a plurality of physical addresses can be returned. In FIG. 1, the TV receiver 101 has only one HDMI terminal.

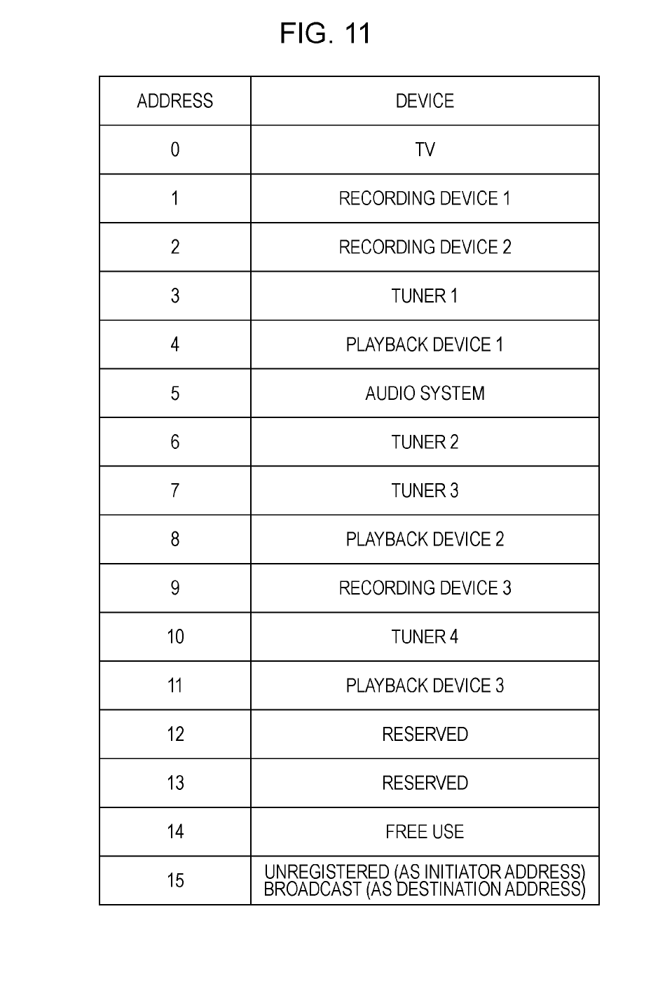

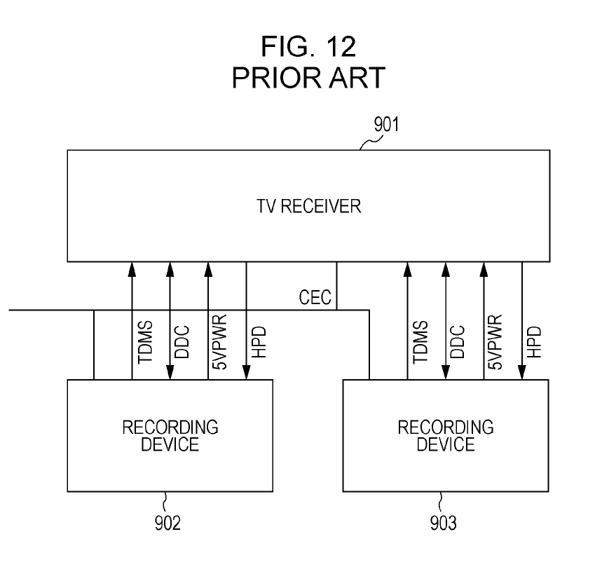

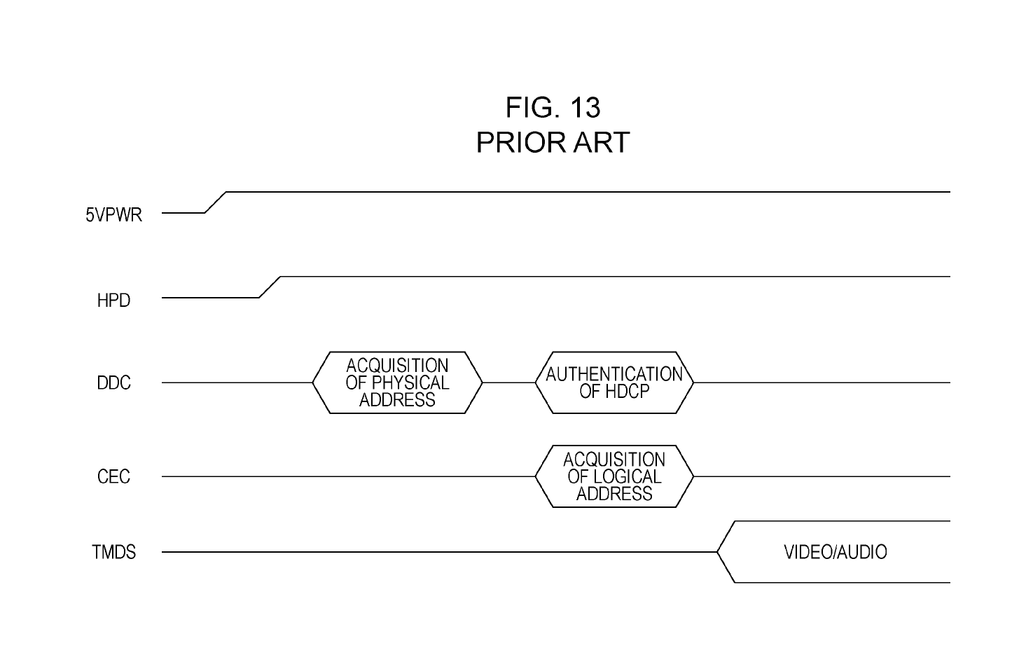

Subsequently, the recording devices 103 to 106 acquire desired logical addresses from among the logical addresses allocated according to each device type (a recording device is allocated one of addresses “1”, “2”, and “9”. Refer to FIG. 11). As a procedure for acquiring the logical addresses, each of the recording devices 103 to 106 transmits a Polling message by broadcast to the desired logical address (for example, “1”). When no response to the message returns from any device (when a message returns with ACK bit=1), this means that no other device has acquired the logical address. Thus, the logical address is acquired. When a response returns (when a message returns with ACK bit=0), on the other hand, the logical address has been acquired by another device. Thus, a logical address is acquired by repeating the same process on the other logical addresses (for example, “2” and “9”). A structure of a header block/data block of the CEC message will be described later.

Further, the communication control unit 1018 has the following configuration to cause a device, which has failed to acquire a logical address, to reacquire a logical address in addition to the control over the allocation of the physical addresses and the logical addresses. More specifically, as shown in a detailed block diagram of FIG. 3, the communication control unit 1018 has the acquired-logical-address detecting unit 201, the device management table 202, the logical-address-non-acquired device detecting unit 203, and the logical address reacquisition controlling unit 204.

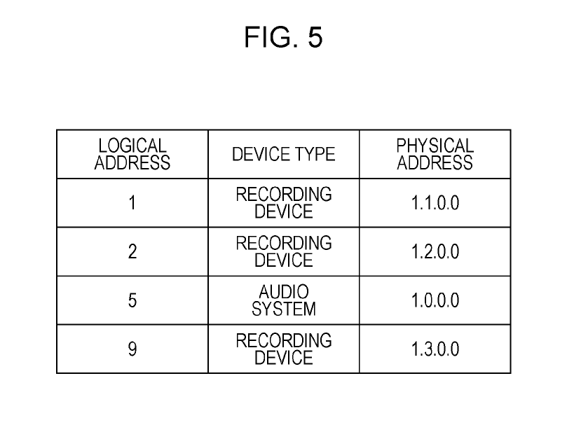

The acquired-logical-address detecting unit 201 detects a device that is connected to the CEC line and that has acquired a logical address. The detection can be performed by transmitting a Polling message or a Give Physical Address message of CEC to logical addresses “1” to “14” and confirming responses thereto. Here, since the logical address “0” is allocated to a television receiver and the logical address “15” is an unregistered address, they are excluded. The detection result is stored in a memory (storage unit) as the device management table 202. FIG. 5 shows an example of the device management table 202. In this example, recording devices (for example, the recording devices 103 to 105) are connected to the three HDMI terminals of the repeater device 102 (the device type of which is an audio system). Since there are three logical addresses allocated to recording devices, it is found that all the logical addresses for recording devices have already been acquired. Further, when a Give Physical Address message is used for detection, as shown in FIG. 5, the physical addresses corresponding to the logical addresses are also found.

Since CEC has a structure in which all devices are connected via a bus, the repeater device 102 connected between the TV receiver 101 and devices connected thereto would not interfere with communication of Polling messages and the like of CEC. Further, disconnection of a specific device from the CEC line can also be detected by regularly performing a process for transmitting the Polling message described above to confirm the connection state of the devices. The acquired-logical-address detecting unit 201 corresponds to a disconnection detection unit according to the present invention.

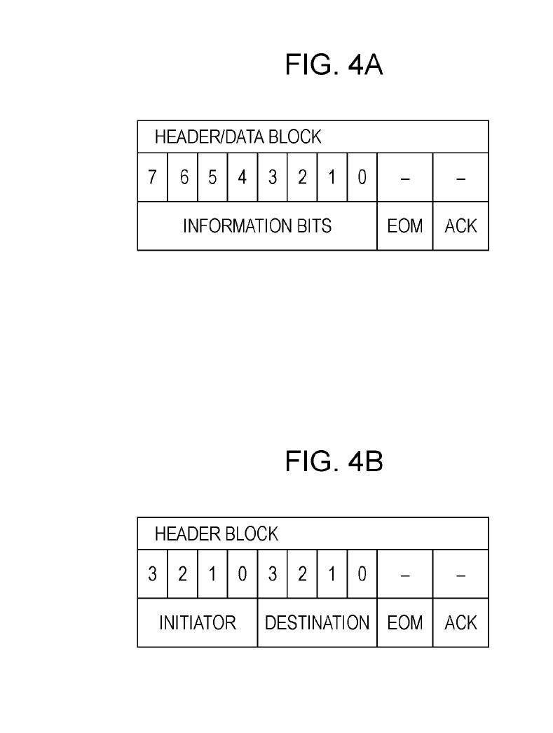

The structure of the header block/data block of the CEC message will now be explained using FIGS. 4A and 4B. All data blocks and all header blocks have the same basic structure of a 10-bit length. FIG. 4A shows the block structure. Information has 8 bits and stores data, operation codes, addresses, and the like. An EOM (End of Message) field and an ACK (Acknowledge) field as control bits exist in each one block. Whether or not there is a block to be transmitted subsequently is set in EOM, and “0” shows that there is a block to be transmitted subsequently and “1” shows a final block. ACK is a response from a transmission destination device, and is set to “0” when the response corresponds to a message, whereas set to “1” when the response does not correspond to the message. FIG. 4B shows the structure of the header block. In the header block, 8-bit information is divided into 4-bit groups, and Initiator and Destination are set to the respective 4-bit groups. The logical address of the message transmitter (the television receiver 101 in the embodiment) is set to Initiator, and the logical addresses of the receivers (for example, the recording devices 103 to 106) are set to Destination.

Accordingly, when, for example, “9” is set as a logical address of a receiver in the Destination address in the Polling message described above, the ACK bit is set to “0” if there is a device which has acquired the logical address “9”. Although, in reality, the CEC line is set to high on the Initiator side and is set to low on the Destination side, the above expression is employed. With this operation, it can be found that the device which has acquired the logical address “9” exists. Likewise, when, for example, “9” is set as a logical address of a receiver in the Destination address in the Give Physical Address message described above, the following response is returned: When there is a device which has acquired the logical address “9”, the ACK bit is set to “0”, and the physical address of the device having the logical address “9” is returned as a response by a message. With this operation, the fact that the device, which has acquired the logical address “9”, exists and the physical address of the device can be found.

When there is no device which has acquired the logical address, the ACK bit of the message block in the message is set to “1” (actually, the CEC line set to high on the Initiator side remains high).

The logical-address-non-acquired device detecting unit 203 detects a device that is connected to the audio visual device system and that has not acquired a logical address because all the logical addresses have already been acquired by devices of the same device type. That is, for example, in a case where the recording devices 103 to 105 are connected to the repeater device 102 and have already acquired logical addresses, the recording device 106 is connected to the repeater device 102. The detection process is performed by specifying a device type for which all the logical addresses in the device management table 202 have already been acquired and detecting a failure to acquire a logical address by a device of this device type. A logical-address-non-acquired device that has not acquired a logical address can be detected by receiving a failure notification in response to a logical address acquisition request, that is, by returning ACK bit “0” in response to a Polling message transmitted by broadcast.

Alternatively, the logical-address-non-acquired device detecting unit 203 may detect a device that has not acquired a logical address by performing the following operations: sequentially transmitting a Polling message or a Give Physical Address message from a certain device to logical addresses of a specific device type and returning ACK bit “0” from all the addresses. For example, when a Polling message is sequentially transmitted to logical addresses “1”, “2”, and “9” and ACK bit “0” is returned from all the addresses, it can be found that the message transmitting device has failed to acquire a logical address.

When the acquired-logical-address detecting unit 201 detects disconnection of, for example, one of the recording devices 103 to 105, the logical address reacquisition controlling unit 204 controls the logical-address-non-acquired device (for example, the recording device 106) detected by the logical-address-non-acquired device detecting unit 203 to reacquire a logical address. The reacquisition control can be performed by turning off the power of the device to which the logical-address-non-acquired device is connected (for example, the repeater device 102) and thereafter turning on the power of the device.

### (Logical Address Reacquisition Controlling Process)

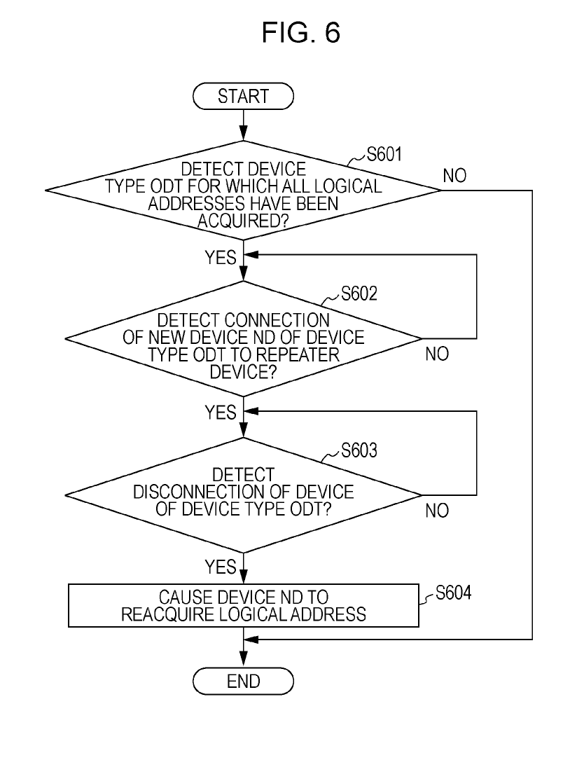

Next, the flow of a process performed by the communication control unit 1018 when there is a device which has failed to acquire a logical address corresponding to a device type will be explained referring to a flowchart of FIG. 6. The process will be started at a time when power is supplied to the television receiver 101 or at predetermined intervals.

The communication control unit 1018 causes the acquired-logical-address detecting unit 201 to detect a device type (hereinafter referred to as a “device type ODT”) for which all the logical addresses have already been acquired (step S601). The device type ODT can be detected by, as described above, transmitting a Ping message or a Give Physical Address command to logical addresses “1” to “14” and monitoring responses thereto.

Then, the communication control unit 1018 causes the logical-address-non-acquired device detecting unit 203 to detect connection of a new device (hereinafter referred to as a “device ND”) of the device type ODT to the repeater device 102 (step S602). The connection of the device ND can be detected by, as described above, transmitting a Polling message by broadcast from the new connected device and monitoring a response thereto (logical address acquisition failure).

Then, the communication control unit 1018 causes the acquired-logical-address detecting unit 201 to detect disconnection of a device of the device type ODT (step S603). The disconnection can be detected by, as described above, transmitting a Ping message to the logical addresses associated with the device type ODT and monitoring a response thereto.

Then, the communication control unit 1018 controls the logical address reacquisition controlling unit 204 to cause the device ND to reacquire a logical address (step S604). The reacquisition can be performed by, as described above, turning off the power of the repeater device 102 to which the device ND is connected and then turning on the power of the repeater device 102 so as to deassert an HPD signal between the device ND and the repeater device 102.

If the device type ODT for which all the logical addresses have already been acquired is not detected in step S601, the logical address reacquisition controlling process ends.

According to the first embodiment, it is possible to cause an audio visual device, which is connected to an input terminal of a repeater and which has failed to acquire a logical address and has not acquired any logical address, to acquire a logical address when it is made available. With this operation, the audio visual device can be subjected to the CEC control.

### Second Embodiment

Subsequently, a second embodiment will be explained.

### Gist of Second Embodiment

In the first embodiment, in order to cause a logical-address-non-acquired device to reacquire a logical address, a process for turning off the power of the repeater device 102 and then turning on the power of the repeater device 102 is performed. Also in the second embodiment, like the first embodiment, a process for turning off the power of the repeater device 102 and then turning on the power of the repeater device 102 is performed in order to cause a logical-address-non-acquired device to reacquire a logical address. The difference between the first and second embodiments is as follows: Before the power of the repeater device 102 is turned off, it is confirmed whether the repeater device 102 is currently in playback mode. After it is confirmed that the repeater device 102 is not currently in playback mode or the playback has been completed, the power of the repeater device 102 is turned off and on.

This can avoid the power of the repeater device 102 from being turned off during playback of music when a user connects or removes a recording device or the like to or from an input terminal of the repeater device 102.

Since the basic configuration of the television receiver 101 according to the present embodiment is the same as that of the first embodiment (FIG. 1), the explanation thereof is omitted.

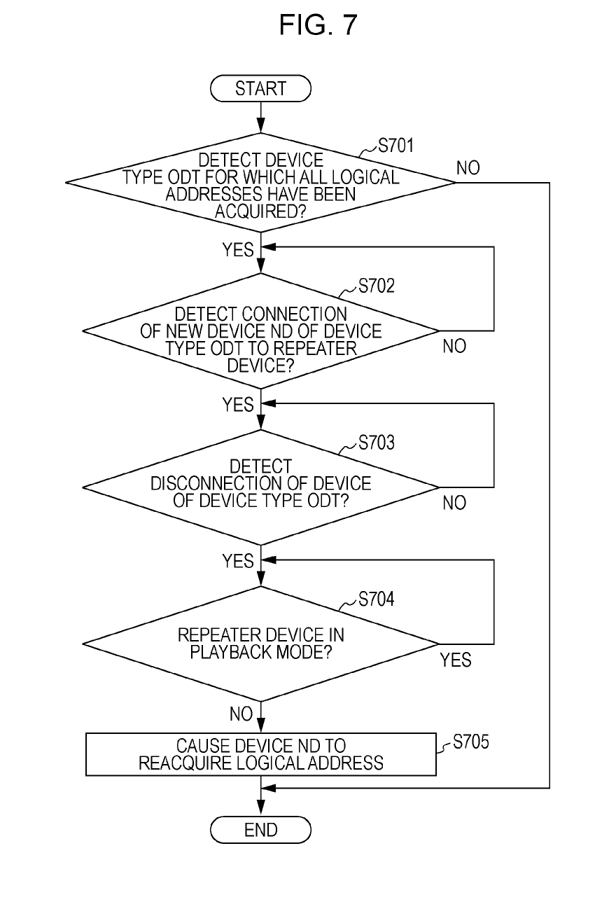

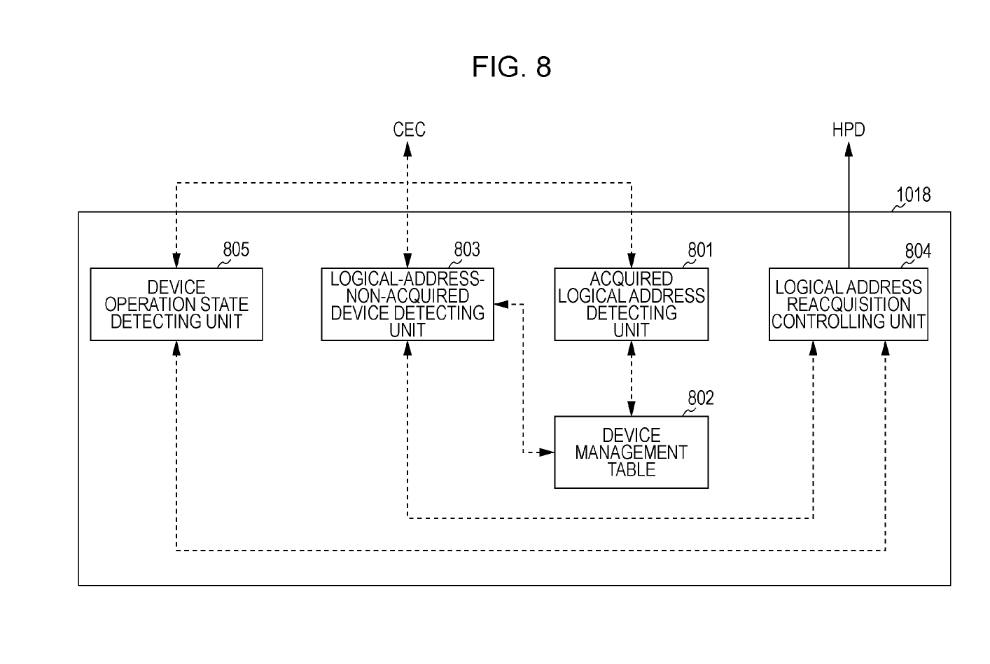

In the present embodiment, since only the configuration of the communication control unit 1018 is different from that in the first embodiment, the configuration will be explained referring to a flowchart of FIG. 7 and a block diagram of FIG. 8.

As shown in FIG. 8, the communication control unit 1018 includes an acquired-logical-address detecting unit 801, a device management table 802, a logical-address-non-acquired device detecting unit 803, a logical address reacquisition controlling unit 804, and a device operation state detecting unit 805.

A logical address reacquisition controlling process performed by the communication control unit 1018 in the present embodiment will be explained referring to the flowchart of FIG. 7. The process will be started at a time when power is supplied to the television receiver 101 or at predetermined intervals.

The communication control unit 1018 causes the acquired-logical-address detecting unit 801 to detect a device type ODT for which all the logical addresses have already been acquired (step S701). The device type ODT can be detected by, as in the first embodiment, transmitting a Ping message or a Give Physical Address command to logical addresses “1” to “14” and monitoring responses thereto.

Then, the communication control unit 1018 causes the logical-address-non-acquired device detecting unit 803 to detect connection of a new device ND of the device type ODT to the repeater device 102 (step S702). The connection of the device ND can be detected by, as in the first embodiment, transmitting a Polling message by broadcast from the new connected device and monitoring a response thereto (logical address acquisition failure).

Then, the communication control unit 1018 causes the acquired-logical-address detecting unit 801 to detect disconnection of a device of the device type ODT (step S703). The disconnection can be detected by, as in the first embodiment, transmitting a Ping message to the logical addresses associated with the device type ODT and monitoring a response thereto.

The communication control unit 1018 causes the device operation state detecting unit 805 to determine whether or not the repeater device 102 is currently in playback mode (step S704). The determination can be performed by, for example, transmitting a Give Audio Status command of CEC and checking a response thereto.

When the repeater device 102 is not currently in playback mode, the communication control unit 1018 controls the logical address reacquisition controlling unit 804 to cause the device ND to reacquire a logical address (step S705). The reacquisition can be performed by, as in the first embodiment, turning off the power of the repeater device 102 to which the device ND is connected and then turning on the power of the repeater device 102 so as to deassert an HPD signal between the device ND and the repeater device 102.

When the repeater device 102 is currently in playback mode, the communication control unit 1018 causes the logical address reacquisition controlling unit 804 to monitor the repeater device 102 until the repeater device 102 is not in playback mode. When the repeater device 102 is not currently in playback mode, the logical address reacquisition controlling unit 804 causes the device ND to reacquire a logical address.

If the device type ODT for which all the logical addresses have already been acquired is not detected in step S701, the logical address reacquisition controlling process ends.

According to the present embodiment, it is possible to cause an audio visual device, which is connected to an input terminal of a repeater and which has failed to acquire a logical address and has not acquired any logical address, to acquire a logical address when it is made available. With this operation, the audio visual device can be subjected to the CEC control. In the present embodiment, furthermore, after it is confirmed whether or not the repeater device 102 is currently in playback mode, the power of the repeater device 102 is turned off. This can avoid the power of the repeater device 102 from being turned off during playback of music.

### Third Embodiment

Subsequently, a third embodiment will be explained.

### Gist of Third Embodiment

In the first embodiment, a process for detecting a device that has failed to acquire a logical address because a number of devices exceeding an upper limit number of logical addresses have been connected, and causing the device to acquire a logical address when it is made available is performed using only a standard message compliant with the HDMI-CEC standard. In the third embodiment, the above process is performed using a vendor unique command of CEC. In this case, it is necessary for a television receiver 101, a repeater device 102, and recording devices 103 to 106 to support the vendor unique command.

This can eliminate the need to turn off the power of the repeater device 102 in order to cause an audio visual device, which has failed to acquire a logical address and has not acquired any logical address, to acquire a logical address when it is made available.

Since the basic configuration of the television receiver 101 according to the present embodiment is the same as that of the first embodiment (FIG. 1), the explanation thereof is omitted.

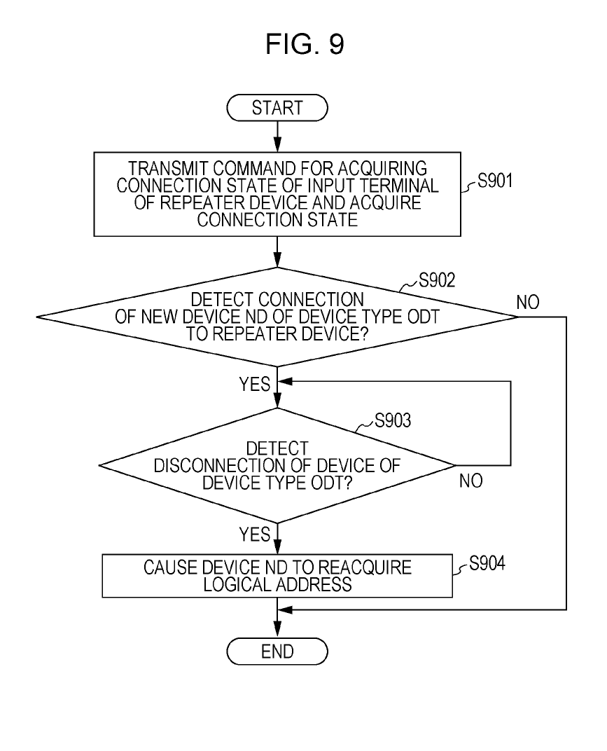

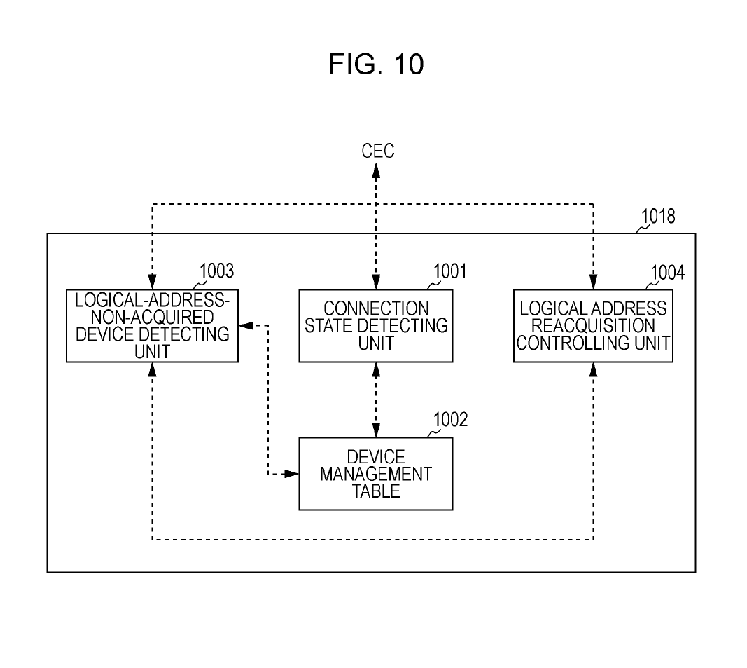

In the third embodiment, since only the configuration of the communication control unit 1018 is different from that of the first embodiment, the configuration will be explained referring to a flowchart of FIG. 9 and a block diagram of FIG. 10.

As shown in FIG. 10, the communication control unit 1018 includes a connection state detecting unit 1001, a device management table 1002, a logical-address-non-acquired device detecting unit 1003, and a logical address reacquisition controlling unit 1004.

A logical address reacquisition controlling process performed by the communication control unit 1018 in the present embodiment will be explained referring to the flowchart of FIG. 9. The process will be started at a time when power is supplied to the television receiver 101 or at predetermined intervals.

The communication control unit 1018 causes the connection state detecting unit 1001 to detect the connection state of each input terminal of the repeater device 102 (step S901). The connection state can be detected by transmitting a CEC message for detecting the connection state of each input terminal from the television receiver 101 to the repeater device 102 and receiving a response thereto.

Then, the communication control unit 1018 causes the logical-address-non-acquired device detecting unit 1003 to detect connection of a new device ND of a device type ODT to the repeater device 102 (step S902). Specifically, both the connection state of each HDMI input terminal of the repeater device 102, which is detected in step S901, and the connection state of each HDMI input terminal of the television receiver 101 are used to manage all the HDMI input terminals. Then, a Polling message is transmitted by broadcast from the new connected device and a response (logical address acquisition failure) thereto is monitored. Accordingly, the connection can be detected.

Then, the communication control unit 1018 causes the connection state detecting unit 1001 to detect disconnection of a device of the device type ODT (step S903). The disconnection of a device of the device type ODT can be detected by transmitting a CEC message for acquiring the connection state of each HDMI input terminal of the repeater device 102 from the television receiver 101 to the repeater device 102 and checking a response thereto.

Then, the communication control unit 1018 controls the logical address reacquisition controlling unit 1004 to cause the device ND to reacquire a logical address (step S904). The reacquisition can be performed by transmitting a CEC message for deasserting an HPD (setting it to low and then setting it to high again), or a logical address reacquisition message from the television receiver 101 to the repeater device 102.

If the connection of a new device ND of the device type ODT to the repeater device 102, for which all the logical addresses have already been acquired, is not detected in step S902, the logical address reacquisition controlling process ends.

According to the present embodiment, it is possible to cause an audio visual device, which is connected to an input terminal of a repeater and which has failed to acquire a logical address and has not acquired any logical address, to acquire a logical address when it is made available. With this operation, the audio visual device can be subjected to the CEC control. According to the present embodiment, furthermore, a logical address can be reacquired without turning on and off the power of the repeater device 102.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-246545 filed Sep. 25, 2008, which is hereby incorporated by reference herein in its entirety.

What is claimed is:

1. A communication control device in an audio visual device system, the audio visual device system being arranged such that a repeater device is connected to an input terminal of the communication control device and a plurality of audio visual devices are connected to a plurality of input terminals of the repeater device, each of the connected audio visual devices being allocated a logical address corresponding to a device type thereof, an upper limit being set on the number of allocatable logical addresses for each device type so that when a number of audio visual devices that exceed the upper limit are connected, an excessive audio visual device is not allocated a logical address corresponding to a device type thereof, the communication control device comprising:
a device detection unit configured to detect an audio visual device which has not acquired a logical address corresponding to a device type of the audio visual device among the plurality of audio visual devices connected to the repeater device;
a disconnection detection unit configured to detect disconnection of an audio visual device from the audio visual device system; and
a control unit configured to perform control for causing the audio visual device detected by the device detection unit to acquire a logical address corresponding to the device type when the disconnection detection unit detects disconnection of an audio visual device.

2. The communication control device according to claim 1, wherein the disconnection detection unit detects disconnection of an audio visual device by regularly checking connection states of the audio visual devices allocated the logical addresses corresponding to the device types.

3. The communication control device according to claim 1, wherein the device detection unit detects an audio visual device which has not acquired a logical address corresponding to a device type of the audio visual device by detecting a failure notification in response to a logical address acquisition request from the audio visual device.

4. The communication control device according to claim 1, wherein the control unit causes the audio visual device detected by the device detection unit to acquire a logical address corresponding to the device type by turning off a power of the repeater device and then turning on the power of the repeater device.

5. The communication control device according to claim 4, wherein when the control unit performs control for causing the audio visual device detected by the device detection unit to acquire a logical address corresponding to the device type, the control unit checks an operation state of the repeater device and performs control for causing the audio visual device detected by the device detection unit to acquire a logical address corresponding to the device type when the repeater device is not currently in playback mode.

6. The communication control device according to claim 1, wherein the control unit causes the audio visual device detected by the device detection unit to acquire a logical address corresponding to the device type by turning off a power of the audio visual device and then turning on the power of the audio visual device.

7. The communication control device according to claim 2, wherein the audio visual device system is a system compatible with a High-Definition Multimedia Interface standard, and
wherein the disconnection detection unit transmits a Ping message of High-Definition Multimedia Interface Consumer Electronics Control to logical addresses corresponding to the device types, and detects disconnection of an audio visual device from the audio visual device system in accordance with responses to the Ping message.

8. The communication control device according to claim 4, wherein the audio visual device system is a system compatible with a High-Definition Multimedia Interface standard, and
wherein the control unit causes the audio visual device detected by the device detection unit to acquire a logical address by setting a Hot-Plug Detect line to which the repeater device is connected to low and then resetting the Hot-Plug Detect line to high.

9. The communication control device according to claim 6, wherein the audio visual device system is a system compatible with a High-Definition Multimedia Interface standard, and
wherein the control unit causes the audio visual device detected by the device detection unit to acquire a logical address corresponding to the device type by transmitting to the repeater device a request for setting a Hot-Plug Detect line to which the repeater device is connected to low and resetting the Hot-Plug Detect line to high.

10. A television receiver comprising:
a tuner unit configured to receive a television broadcast signal;
a display unit configured to display the received television broadcast signal; and
the communication control device according to claim 1.

11. A communication control method in an audio visual device system, the audio visual device system being arranged such that a repeater device is connected to an input terminal of the communication control device and a plurality of audio visual devices are connected to a plurality of input terminals of the repeater device, each of the connected audio visual devices being allocated a logical address corresponding to a device type thereof, an upper limit being set on the number of allocatable logical addresses for each device type so that when a number of audio visual devices that exceed the upper limit are connected, an excessive audio visual device is not allocated a logical address corresponding to a device type thereof, the communication control method comprising:
a device detection step of detecting an audio visual device which has not acquired a logical address corresponding to a device type of the audio visual device among the plurality of audio visual devices connected to the repeater device;
a disconnection detection step of detecting disconnection of an audio visual device from the audio visual device system; and
a control step of performing control for causing the audio visual device detected in the device detection step to acquire a logical address corresponding to the device type when disconnection of an audio visual device is detected in the disconnection detection step.
